(19) United States
(12) Patent Application Publication
(10) Pub. No.: US 2002/0174028 A1
(43) Pub. Date: Nov. 21, 2002

(54) System and method for processing orders including bundling and unbundling ordered products

(76) Inventors: Michelle Anderson, Lynnwood, WA (US); Scott Volz, Maple Valley, WA (US)

Correspondence Address: NIXON & VANDERHYE P.C., 8th Floor, 1100 North Glebe Road, Arlington, VA, 22201, US

(21) Appl. No.: 09/927,452

(22) Filed: Aug. 13, 2001

Related U.S. Application Data
(60) Provisional application No. 60/290,982, filed on May 16, 2001.

(51) Int. Cl. G06F 17/60

(52) U.S. Cl. 705/26

(57) ABSTRACT

A method and system of processing an order comprises receiving an order indicating N desired items, bundling the N desired items of the order as M unit(s), each unit comprising a collection of at least one desired item and M being a number lower than N, and processing the order using the M unit(s) as a representation of the N desired items. After processing the order using the M unit(s), the representation of the M unit(s) is unbundled into N desired items. Alternatively, a method and system of processing an order comprises receiving an order for M unit(s), each unit comprising a plurality of individual items, unbundling the M unit(s) of the order as N individual items, M being a number lower than N, and processing the order using N individual items as a representation of the M unit(s). After processing the order using the N individual items, the representation of the N individual items is bundled as M unit(s).

### CROSS REFERENCE TO RELATED APPLICATION

This application claims the benefit of U.S. Provisional Application No. 60/209,982 filed May 16, 2001, the contents of which are incorporated herein by reference.

### BACKGROUND OF THE INVENTION

1. Field of the Invention

The present invention relates to a system and method for processing orders, and in particular to a system and method in which the number of items indicated in an order is translated into and represented as a different number and processed using that different number.

2. Description of Related Art

An order placed by a customer with a vendor will normally indicate the number of item(s) desired. The vendor's order processing system will receive and process the order using the number of item(s) indicated by the order. The order processing system will ultimately generate and send a notice (e.g., an invoice, advance shipping notice (ASN), etc.) to the customer indicating the number of item(s) either ordered, allocated for shipment, and/or shipped. It may be beneficial for the number of item(s) indicated on the notice to match the number of item(s) indicated on the order so that a determination can be easily made that the item(s) received matches what was originally ordered.

In a “standard” order processing scenario, if a customer transmits an order, for example, that indicates “5” individual items, the vendor's order processing system will process the order as five individual items. Specifically, the order processing system will allocate five items for picking and decrement the vendor's accounting of the inventory by five items. The order processing system will generate and send a notice to the customer indicating “5” items, the same number indicated on the original order. This notice may be sent with the shipment of the ordered items.

In other scenarios, however, a customer will not be able to provide an order for a desired product in a format that is consistent with the format required by the vendor's ordering processing system. For example, suppose a vendor sells a product that consists of a collection of individual items within a display stand. The vendor's inventory and order processing system will account for and process this product as a single (1) unit, even though it consists of individual components. A customer, however, may be limited to providing an order that indicates the same product as individual items. The order for the desired product from the customer is thus formatted on an individual item basis whereas the vendor offers and processes the same product in its order processing system on a collective unit basis.

After receiving such a differently formatted order, the vendor may be forced to reject the order entirely since the system's requirements are not met, or the vendor may ship the individual items in an “uncollected” state (e.g., ship the individual items without a display stand). Neither of these responses from the vendor would not match the customer's intent or satisfy the customer. Even if the display stand were ordered individually, the customer would have to coordinate the respective arrival times of the display stand and the individual items. The customer would also have to exert extra effort to place the individual items into the display stand. This would have been already done if the customer had received the collective product comprising both the individual items and display stand. Moreover, even if the order is processed the customer may not be able to properly handle being invoiced for a single unit if its order indicated individual items. That is, the customer may have an order and receiving system which may not be able to properly process or at least have difficulty in properly processing an invoice that indicates a different quantity than indicated on the order.

It would thus be beneficial to provide an order processing system that is capable of accommodating an order that indicates a desired product in a format which is different than the format which the system normally uses to process the order.

### BRIEF SUMMARY OF THE INVENTION

In an exemplary embodiment of the invention, a method of processing an order (and a corresponding system for processing an order) comprises receiving an order indicating N desired items, bundling the N desired items of the order as M unit(s), each unit comprising a collection of at least one desired item and M being a number lower than N, and processing the order using the M unit(s) as a representation of the N desired items. After processing the order using the M unit(s), the representation of the M unit(s) is unbundled into N desired items. A notice may then be generated indicating a number that is equal to N so that the number indicated on the notice matches the number N indicated on the order. Processing the order using the M unit(s) includes decreasing an inventory count of the unit(s) by a value equal to M. The N desired items may be shipped together as one collective package. Alternatively, after processing the order using the M unit(s), a notice may be generated indicating a number that is equal to M so that the number indicated on the notice mismatches the number N indicated on the order.

A customer's order indicating a plurality of items may thus be “bundled”, for example, as a single unit by a vendor's order processing system and later processed as a single unit by the order processing system as opposed to the using the number of items indicated on the order. The order processing system processes the order using a different format (e.g., using a different number) than what is presented in the order itself. After being bundled and processed, for example, as a single unit, the system can generate a notice such as an ASN or invoice indicating the “unbundled” number of items. The customer can therefore receive a notice indicating the same number of items that was indicated on the order despite the order processing system actually processing the order as, for example, a single unit.

In another exemplary embodiment of the invention, a method of processing an order (and a corresponding system for processing the order) comprises receiving an order for M unit(s), each unit comprising a plurality of individual items, unbundling the M unit(s) of the order as N individual items, M being a number lower than N, and processing the order using N individual items as a representation of the M unit(s). After processing the order using the N individual items, the representation of the N individual items is bundled as M unit(s). A notice is then generated indicating a number that is equal to M so that the number indicated on the notice matches the number M indicated on the order. Processing the order using the N individual items includes decreasing an inventory count of the items by a value equal to N. Alternatively, after processing the order using N items, a notice may be generated indicating a number equal to N so that the number indicated on the notice mismatches the number M indicated on the order.

For example, a customer's order for a single unit may thus be “unbundled” into its component individual items by the order processing system. The system then uses the unbundled number of individual items, as opposed to the single unit indicated in the order, to process the order. After being unbundled and processed as a plurality of items, the system can generate a notice indicating the bundled number of units. The customer can therefore receive a notice indicating the same number of units that was indicated on the order despite the system actually processing the order as a (different) unbundled number of items.

In another exemplary embodiment of the invention, a method of processing an order (and a corresponding system for processing the order) comprises receiving an order that indicates X item(s), translating and representing the X items(s) as Y item(s), Y being a number having a different value than the number X, and processing the order using data representative of a value equal to Y. The method further comprises re-translating and re-representing the Y item(s) as X item(s) after processing the order using the data representative of a value equal to Y. After processing the order using data representative of a value equal to Y, a notice may be generated indicating a number that is equal to X so that the number indicated on the notice matches the number X indicated on the order. Alternatively, after processing the order using data representative of a value equal to Y, a notice may be generated indicating a number that is equal to Y so that the number indicated on the notice mismatches the number X indicated on the order. Processing the order using the value equal to Y may include decreasing an inventory count of the ordered item(s) by a value equal to Y.

### BRIEF DESCRIPTION OF THE DRAWINGS

The above advantages, as well as other advantages of this invention, will be more completely understood and appreciated by careful study of the following more detailed description of the invention taken in conjunction with the accompanying drawings, in which:

FIG. 1 is a diagram illustrating a system for processing orders from a customer in accordance with an exemplary embodiment of the invention;

FIG. 2 is a diagram illustrating a method of processing orders in accordance with an exemplary embodiment of the invention using the system illustrated in FIG. 1;

FIG. 3 is a flow chart describing the method of processing orders in accordance with the exemplary embodiment illustrated in FIG. 2;

FIG. 4 is a diagram illustrating a method of processing orders in accordance with another exemplary embodiment of the invention using the system illustrated in FIG. 1; and

FIG. 5 is a flow chart describing the method of processing orders in accordance with the exemplary embodiment illustrated in FIG. 4.

### DETAILED DESCRIPTION OF THE INVENTION

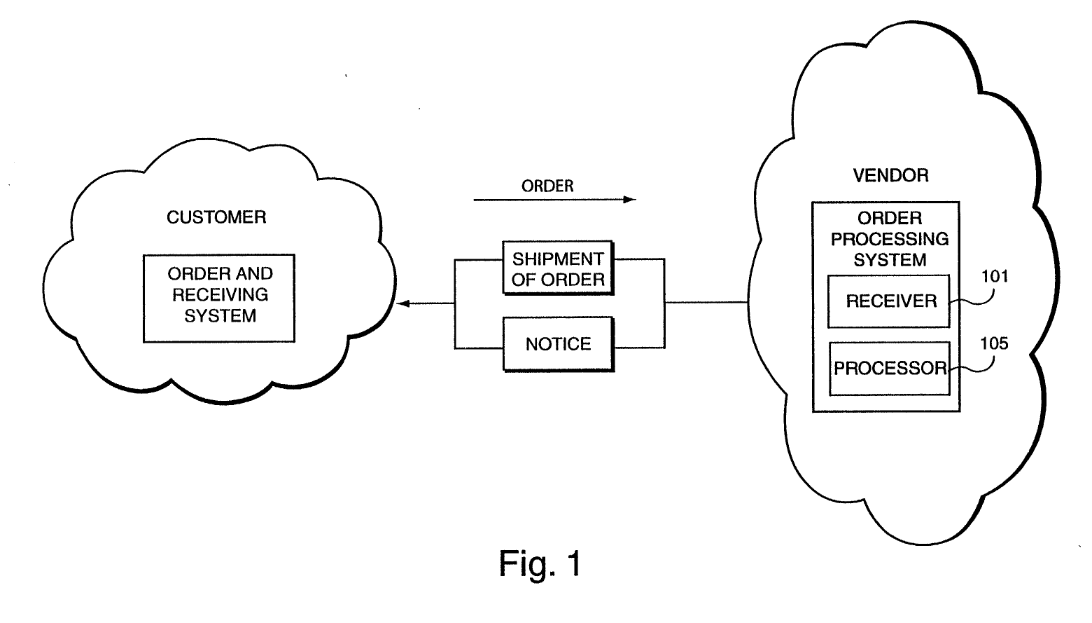

FIG. 1 illustrates, inter alia, a computerized order processing system according to an exemplary embodiment of the present invention. As illustrated in FIG. 1, the computerized order processing system includes a receiver 101 and a processor 105. A vendor implementing the order processing system may receive orders from a customer via the electronic document interchange (EDI), a standard that has developed in the shipping industry. Alternatively, the orders may be received by the system via manual input by the vendor's personnel. The customer itself may have an order and receiving system for tracking inventory. While only one customer is shown in FIG. 1, it will be appreciated that a plurality of different customers can transmit orders to the vendor via the EDI.

After receiving an order through receiver 101, the order processing system will forward the order to the processor 105. The processor 105 is capable of first “bundling” or “unbundling” an order. That is, the processor 105 is capable of translating and representing the item(s) or unit(s) indicated in the received order in a different format as will be discussed in more detail below. The processor 105 is capable of further processing the order using the bundled or unbundled representation of the ordered item(s) or unit(s) including outputting a notice such as an ASN or invoice to the customer.

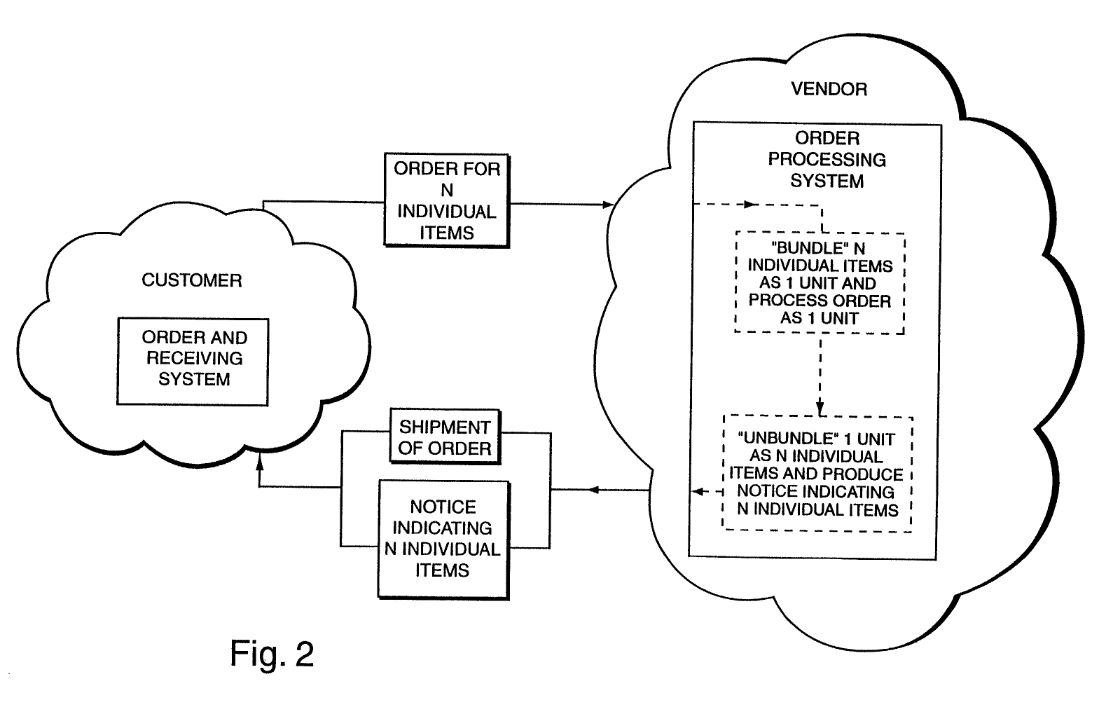

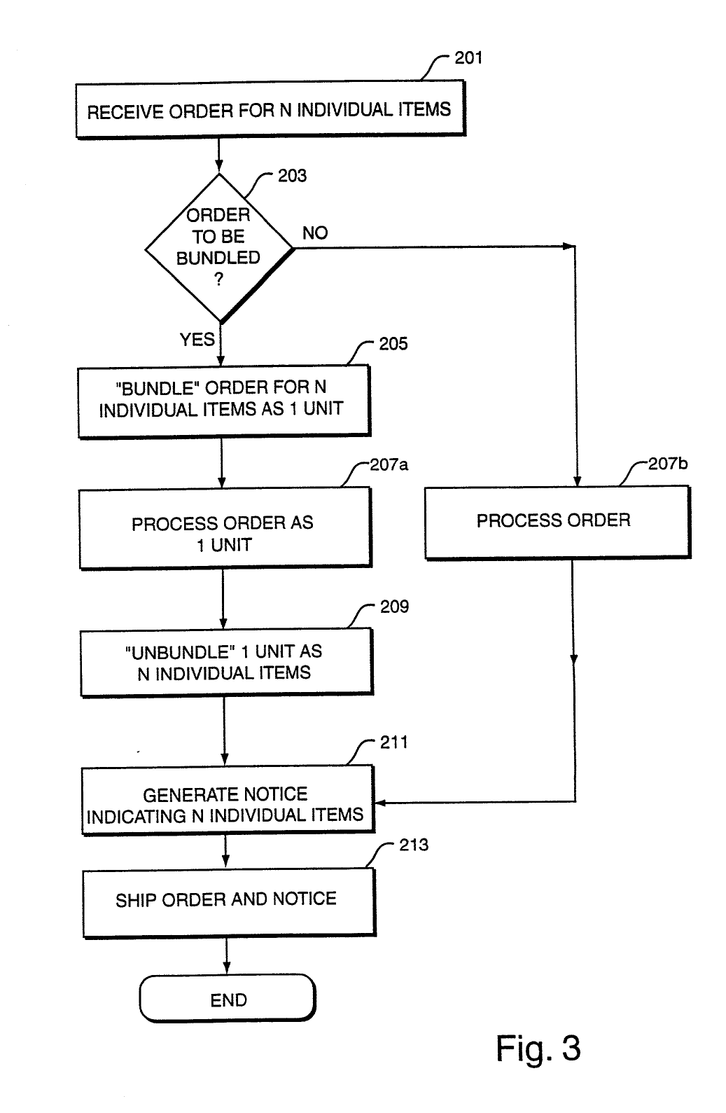

FIGS. 2-3 illustrate a method of processing orders according to an exemplary embodiment of invention which may be implemented using the system shown in FIG. 1. In this exemplary embodiment, a single (1) unit sold by the vendor comprises N individual items. In order to facilitate a clear understanding of the invention, N is defined as having an exemplary value of ten in the discussion below, although those skilled in the art will understand that N can be defined as any number defining a plurality of items. Also, while the ten individual items are translated and represented by the order processing system as a single (1) unit, it will be understood that the ten items could be translated and represented as a different number, such as two. (i.e., two units of five items).

As shown in FIG. 2, the customer first transmits an order which indicates its desire for the single unit sold by the vendor. However, rather than indicating “1” unit, the transmitted order indicates the “10” (N=10 in this example) individual items which constitute the unit. This would occur, for example, if the customer's receiving and ordering system is limited to ordering and tracking received products on an individual item basis. The order is received by the order processing system (step 201) and evaluated to determined if the order indicating “10” individual items can be properly bundled (i.e., translated into and represented by a number having a lower value) by the processor 105 as one collective unit (step 203). This evaluation involves determining through a computerized process and/or through the manual evaluation by the vendor's personnel if the ten individual items listed in the order properly constitutes the collective single unit. The evaluation therefore involves determining whether the order would have indicated an order for “1” unit if the order were written in accordance with the format used and preferred by the order processing system.

If it is determined that the individual items indicated in the order cannot be properly bundled, then the system attempts to process the order (step 207b) using data representing the number provided in the order. If, on the other hand, it is determined that the ten individual items indicated in the order should be properly bundled as one unit, then the processor translates and represents the ten individual items as one unit (step 205). This data representation of the ordered product(s) as one unit, rather than ten individual items, is used in the processing of the order (step 207a). For example, the vendor allocates, picks, ships and decrements the vendor's inventory by a value of one unit. Although the customer may track the order as “10” individual items, the vendor tracks and processes the order as “1” unit after bundling.

After the processing (step 207a) is completed, the processor 105 “unbundles” the data representation of one unit back into the ten individual items (step 209). That is, the processor 105 re-translates and re-represents data representative of the one unit back into data representative of ten individual items. The processor 105 then generates a notice such as an ASN or an invoice to the customer which indicates that what has been ordered, allocated for shipment and/or shipped is “10” individual items (step 211). The notice thus indicates the quantity of what is ordered, allocated and/or shipped in its unbundled form, in this example “10.” Indicating “10”, the unbundled form of the quantity of items, on the notice has the benefit of enabling the customer to easily determine whether what is indicated on the notice matches what was indicated on the original order transmitted to the vendor. The notice and shipment of the one unit comprising the ten individual items is ultimately sent to the customer (step 213). Since the number of items (“10”) indicated on the order matches the number indicated on the notice (“10”), the customer may have no idea that the vendor processed, at least in part, the order using a bundled representation.

Accordingly, the exemplary embodiment illustrated in FIGS. 2-3 properly processes an order from a customer that needs to order and receive a product sold by a vendor as a collective unit using an individual item format. This is accomplished as described above by bundling the “10” individual items indicated on the order as “1” unit and processing the order using the data representative of “1” unit rather than the “10” individual items. The data representative of “1” unit may then be unbundled back to the “10” individual items so that a notice which indicates a quantity that matches the order may be generated. Other customers may transmit an order indicating “1” unit. The present invention will assist the vendor to enhance customer satisfaction by allowing a customer to format its order as it wishes. Also, the vendor can avoid any penalty fee filed by a customer for allegedly failing to send a product that does not match what the customer specified in its order.

The embodiment illustrated in FIGS. 2-3 may be altered so that after the ten items indicated in the order were bundled as one unit, the data representing one unit is not unbundled back to data representing ten individual items. That is, the embodiment illustrated in FIGS. 2-3 could be altered to skip step 209 so that the process would immediately proceed to step 211 after step 207a. Accordingly, the notice generated in step 211 and output in step 213 would indicate that “1” unit was ordered, allocated or shipped. The quantity “1” unit on the notice would thus mismatch the quantity “10” individual items indicated on the order transmitted to the vendor.

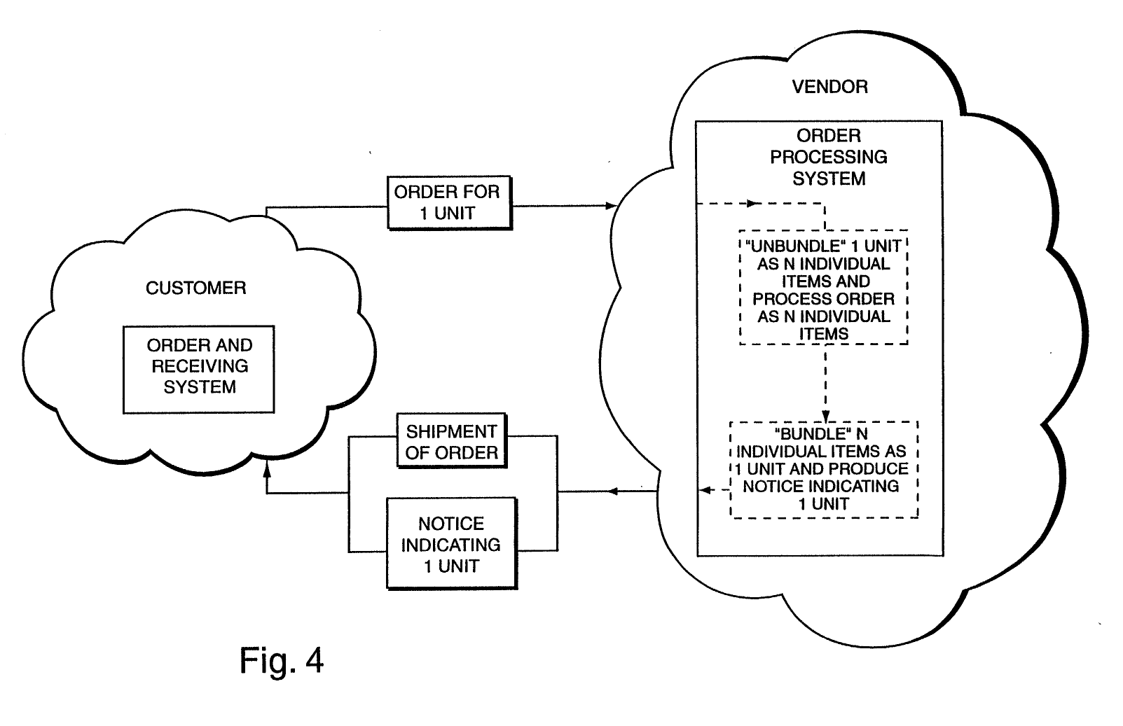

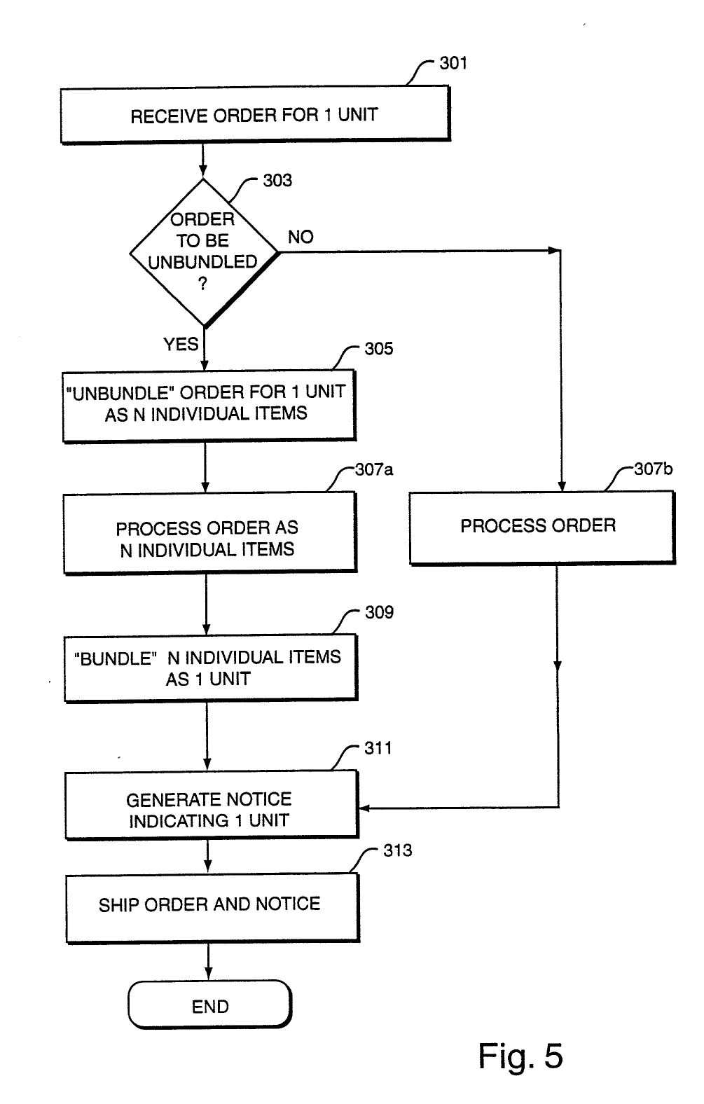

FIGS. 4-5 illustrate a method of processing orders according to another exemplary embodiment of the invention which may be implemented using the system illustrated in FIG. 1. In this exemplary embodiment, the vendor offers N individual items which are not sold as one single bundle. In order to facilitate a clear understanding of the invention, N is defined as having an exemplary value of twenty in the discussion below, although it will be understood that N can be defined as any number defining a plurality of items. Also, while the example discussed below describes a single (1) unit being unbundled into twenty individual items, it will be understood that more than a single unit could be unbundled into a plurality of individual items (e.g., two units of ten items).

As shown in FIG. 4, the customer first transmits an order which indicates its desire for the twenty individual items sold by the vendor. However, rather than indicating “20” individual items, the transmitted order indicates “1” unit. This would occur, for example, if the customer erroneous believed that the 20 individual items offered by the vendor were sold as one collective unit or if the customer's receiving and ordering system is limited to ordering and tracking received products on a collective unit basis. This order is received by the ordering processing system (step 301) and evaluated to determine if the order indicating “1” unit can be properly unbundled (i.e., translated and represented by a number having a higher value) by the processor 105 as twenty individual items (step 303). This evaluation involves determining through a computerized process and/or through the manual evaluation by the vendor's personnel if the “1” unit listed in the order properly comprises the twenty individual items. The evaluation therefore involves determining whether the order should have indicated an order for “20” individual items in accordance with the format used and preferred or required by the order processing system.

If it is determined that the order cannot be properly unbundled, then the order processing system attempts to process the order (step 307b) using data representing the number provided in the order. If, on the other hand, it is determined that the “1” unit indicated in the order can be properly unbundled as twenty individual units, the processor translates and represents the one unit listed on the order as twenty individual items (step 305). This data representation of twenty individual items, rather than one unit, is used in the processing of the order (step 307a). For example, the vendor allocates, picks, ships and decrements the vendor's inventory by a value of twenty items.

After the processing (step 307a) is completed, the processor 105 “bundles” the data representing of twenty individual items back into the one unit (step 309). That is, the processor 105 re-translates and re-represents the data representative of twenty items back into data representative of one unit. The processor 105 then generates a notice such as an ASN or an invoice to the customer which indicates that what has been ordered, allocated for shipment and/or shipped is “1” unit (step 311). The notice thus indicates the quantity of what is ordered, allocated and/or shipped in its bundled form, in this example “1.” Indicating “1”, the bundled form of the quantity of units, on the notice has the benefit of enabling the customer to easily determine whether what is indicated on the notice matches what was indicated on the original order transmitted to the vendor. The notice and shipment of the twenty individual items is ultimately sent to the customer (step 313).

Accordingly, the exemplary embodiment illustrated in FIGS. 4-5 properly processes an order from a customer who transmits an order using a collective unit format, rather than in an individual item format preferred or required by the order processing system of the vendor. This is accomplished as described above by unbundling the “1” unit indicated on the order as “20” individual items and processing the order using the data representation of “20” individual items rather than the “1” unit. The data representation of “20” individual items may be bundled to “1” unit so that a notice which indicates a quantity matches the order may be generated. Of course, other customers may transmit an order for “20” individual items. The present invention will assist the vendor to enhance customer satisfaction by allowing a customer to format its order as it wishes. Also, the vendor can avoid any penalty fee filed by the customer for allegedly failing to send a quantity of product that matches what the customer specified in its order.

The embodiment illustrated in FIGS. 4-5 may be altered so that after the “1” unit indicated in the order is unbundled as twenty individual items, the data representing twenty items is not bundled back to data representing the one individual unit. That is, the embodiment illustrated in FIGS. 4-5 could be altered to skip step 309 so that the process would immediately proceed to step 311 after step 307a. Accordingly, the notice generated in step 311 and the output in step 313 would indicate that “20” items were ordered, allocated or shipped. The quantity “20” items on the notice would thus mismatch the quantity “1” unit indicated on the order transmitted to the vendor.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of processing an order comprising:
receiving an order indicating N items;
bundling the N items of the order as M unit(s), each unit comprising a collection of at least one item and M being a number lower than N; and
processing the order using the M unit(s) as a representation of the N items.

2. The method of claim 1 further comprising: after processing the order using the M unit(s), unbundling the M unit(s) into N items.

3. The method of claim 2 further comprising: after processing the order using the M unit(s), generating a notice indicating a number that is equal to N so that the number indicated on the notice matches the number N indicated on the order.

4. The method of claim 1 wherein processing the order using the M unit(s) includes decreasing an inventory count of the unit(s) by a value equal to M.

5. The method of claim 1 further comprising: shipping the N items together as one collective package.

6. The method of claim 1 further comprising: after processing the order using M unit(s), generating a notice indicating a number that is equal to M so that the number indicated on the notice mismatches the number N indicated on the order.

7. A method of processing an order comprising:
receiving an order indicating M unit(s), each unit comprising a plurality of individual items;
unbundling the M unit(s) of the order as N individual items, M being a number lower than N; and
processing the order using N individual items as a representation of the M unit(s).

8. The method of claim 7 further comprising: after processing the order using the N individual items, bundling the N individual items as M unit(s).

9. The method of claim 8 further comprising: after processing the order using the N individual items, generating a notice indicating a number that is equal to M so that the number indicated on the notice matches the number M indicated on the order.

10. The method of claim 7 wherein processing the order using the N individual items includes decreasing an inventory count of the items by a value equal to N.

11. The method of claim 7 further comprising: after processing the order using N items, generating a notice indicating a number equal to N so that the number indicated on the notice mismatches the number M indicated on the order.

12. A method of processing an order comprising:
receiving an order that indicates X item(s);
translating and representing the X items(s) as Y item(s), Y being a number having a different value than a number X;
processing the order using data representative of a value equal to Y.

13. The method of claim 12 wherein the value of X is higher than the value of Y.

14. The method of claim 12 wherein the value of X is lower than the value of Y.

15. The method of claim 12 further comprising: re-translating and re-representing the Y item(s) as X item(s) after processing the order using data representative of the value equal to Y.

16. The method of claim 15 further comprising: after processing the order using data representative of a value equal to Y, generating a notice indicating a number that is equal to X so that the number indicated on the notice matches the number X indicated on the order.

17. The method of claim 12 further comprising after processing the order using a value equal to Y, generating a notice indicating a number that is equal to Y so that the number indicated on the notice mismatches the number X indicated on the order.

18. The method of claim 12 wherein processing the order using data representative of the value equal to Y includes decreasing an inventory count of ordered item(s) by a value equal to Y.

19. An order processing system comprising:
a receiver for receiving an order indicating N items; and
a processor for bundling the N items as M unit(s), each unit comprising a collection of at least one item and M being a number lower than N, and for processing the order using the M unit(s) as a representation of the N items.

20. The system of claim 19 wherein the processor unbundles the M unit(s) as N items after processing the order using the M unit(s) as a representation of the N items.

21. The system of claim 20 wherein the processor generates a notice indicating a number that is equal to N so that the number indicated on the notice matches the number N indicated on the order.

22. The system of claim 19 wherein the processor decrements an inventory count of the unit(s) by a value equal to M.

23. The system of claim 19 wherein the system enables the N ordered item(s) to be shipped together as one collective package.

24. The system of claim 19 wherein the processor generates a notice indicating a number that is equal to M so that the number indicated on the notice mismatches the number N indicated on the order.

25. A system for processing an order comprising:
a receiver for receiving an order for M unit(s), each unit comprising a plurality of individual items; and
a processor for unbundling the M unit(s) as N individual items, M being a number lower than N, and for processing the order using the N individual items as a representation of the M unit(s).

26. The system of claim 25 wherein the processor bundles the N individual items as M unit after the processing the order using the N individual items as a representation of the M unit(s).

27. The system of claim 26 wherein the processor generates a notice indicating a number that is equal to M so that the number indicated on the notice matches the number M indicated on the order.

28. The system of claim 25 wherein the processor decrements an inventory count of the ordered items by a value equal to N.

29. The system of claim 25 wherein the processor generates a notice indicating a number that is equal to N so that the number N indicated on the notice mismatches the number M indicated on the order.

30. A system for processing orders comprising:
a receiver for receiving an order that indicates X item(s); and
a processor for translating and representing the X items(s) indicated on the order as Y item(s), X and Y being numbers having different values, and for processing the order using data representative of a value equal to Y.

31. The system of claim 30 wherein the value of X is higher than the value of Y.

32. The system of claim 30 wherein the value of X is lower than the value of Y.

33. The system of claim 30 wherein the processor re-translates and re-represents the Y items(s) as X item(s) after processing the order using a value equal to Y.

34. The system of claim 33 wherein the processor generates a notice indicating a number that is equal to X so that the number indicated on the notice matches the number X indicated on the order.

35. The system of claim 30 wherein the processor decrements an inventory count of the item(s) in inventory by a value equal to Y.

36. The system of claim 30 wherein the processor generates a notice indicating a number that is equal to Y so that the number indicated on the notice mismatches the number X indicated on the order.
